(19) United States
(12) Patent Application Publication
(10) Pub. No.: US 2013/0205253 A1
(43) Pub. Date: Aug. 8, 2013

(54) METHOD AND SYSTEM FOR COMPLETING SCHEDULE INFORMATION, AND COMPUTER-READABLE RECORDING MEDIUM HAVING RECORDED THEREON PROGRAM FOR EXECUTING THE METHOD

(71) Applicants: Jong-hyun RYU, Suwon-si (KR); Nam-wook Kang, Seoul (KR); Sin-ae Kim, Suwon-si (KR); Young-sun Kim, Suwon-si (KR); Seung-eok Choi, Suwon-si (KR)

(72) Inventors: Jong-hyun RYU, Suwon-si (KR); Nam-wook Kang, Seoul (KR); Sin-ae Kim, Suwon-si (KR); Young-sun Kim, Suwon-si (KR); Seung-eok Choi, Suwon-si (KR)

(73) Assignee: Samsung Electronics Co., Ltd., Suwon-si (KR)

(21) Appl. No.: 13/612,256

(22) Filed: Sep. 12, 2012

(30) Foreign Application Priority Data
Feb. 7, 2012 (KR) 10-2012-0012530

(51) Int. Cl. G06F 17/30; G06F 3/048

(52) U.S. Cl. 715/810; 707/736; 707/E17.045

(57) ABSTRACT

Methods and apparatus are provided for completing schedule information. A device displays keyword information corresponding to at least one piece of character information, and at least one piece of recommended schedule information selected from a plurality of domains and having a correlation with the keyword information, in response to inputting the at least one piece of character information. Schedule information is automatically completed according to at least a selection of a piece of recommended schedule information from the displayed at least one piece of recommended schedule information.

### PRIORITY

This application claims priority under 35 U.S.C. §119(a) to Korean Patent Application No. 10-2012-0012530, filed on Feb. 7, 2012, in the Korean Intellectual Property Office, the disclosure of which is incorporated herein by reference.

### BACKGROUND OF THE INVENTION

1. Field of the Invention

The present invention relates generally to schedule information processing, and more particularly, to a method and system for completing schedule information, and a computer-readable recording medium having recorded thereon a program for executing the method.

2. Description of the Related Art

When schedule information is completed using a device such as a smart phone or a tablet Personal Computer (PC), a user is required to input items of schedule information one by one. Specifically, when a schedule application (or a diary application) is executed in the smart phone or the tablet PC, the user inputs the schedule information according to schedule items provided by the schedule application.

Accordingly, the user needs to know accurate schedule information according to schedule items provided by the schedule application. However, it is possible for the user to have incorrect schedule information. Thus, in order to prevent schedule information from being completed with incorrect details, the user may perform an online or offline check of schedule information, which is to be input, or the user may search for pre-stored schedule information, before inputting new schedule information. When schedule information is checked online or offline or when pre-stored schedule information is searched for, as described above, a process of inputting the schedule information may be lengthy and inconvenient.

In a schedule application where schedule information is completed in a text form based on a determined rule, the user must know all of the schedule information, as well as the rule used to input the schedule information.

As described above, since schedule information is directly input by the user, it is limited to that which is known by the user.

### SUMMARY OF THE INVENTION

The present invention has been made to address at least the above problems and/or disadvantages and to provide at least the advantages described below. Accordingly, an aspect of the present invention provides a method and system for automatically completing schedule information quickly and easily by using recommended schedule information based on a character input of a user, and a computer-readable recording medium having recorded thereon a program for executing the method.

Another aspect of the present invention provides a method and system for automatically completing schedule information about various details by using recommended schedule information based on a character input of a user.

According to an aspect of the present invention, a method is provided for completing schedule information, which is performed by a device. The device displays keyword information corresponding to at least one piece of character information, and at least one piece of recommended schedule information selected from a plurality of domains and having a correlation with the keyword information, in response to inputting the at least one piece of character information. Schedule information is automatically completed according to at least a selection of a piece of recommended schedule information from the displayed at least one piece of recommended schedule information.

According to another aspect of the present invention, an article of manufacture is provided for completing schedule information, which includes a machine readable medium containing one or more programs which when executed implement the steps of displaying, on the device, keyword information corresponding to at least one piece of character information, and at least one piece of recommended schedule information selected from a plurality of domains and having a correlation with the keyword information, in response inputting the at least one piece of character information; and automatically completing schedule information according to at least a selection of a piece of recommended schedule information from the displayed at least one piece of recommended schedule information.

According to another aspect of the present invention, a method is provided for completing schedule information, which is performed by a server. At least one piece of character information is received from a device. Keyword information corresponding to the at least one piece of character information is obtained. At least one piece of recommended schedule information selected from a plurality of domains, is obtained based on the keyword information. The keyword information and the at least one piece of recommended schedule information are transmitted to the device. The device automatically completes schedule information by using the keyword information and the at least one piece of recommended schedule information.

According to another aspect of the present invention, an article of manufacture is provided for completing schedule information, which includes a machine readable medium containing one or more programs which when executed implement the steps of receiving at least one piece of character information from a device; obtaining keyword information corresponding to the at least one piece of character information; obtaining at least one piece of recommended schedule information selected from a plurality of domains, based on the completed keyword information; and transmitting the keyword information and the at least one piece of recommended schedule information to the device. The device automatically completes schedule information by using the keyword information and the at least one piece of recommended schedule information.

According to another aspect of the present invention, a device is provided that includes a storage unit for storing at least one program, a user interface unit for interacting with a user, and at least one processor for executing the at least one program. The at least one program includes a command to display keyword information corresponding to at least one piece of character information, and at least one piece of recommended schedule information selected from a plurality of domains, on the user interface unit, in response to inputting the at least one piece of character information through the user interface unit. The at least one program also includes a command to automatically complete schedule information according to at least a selection of a piece of recommended schedule information from the displayed at least one piece of recommended schedule information, by using the user interface unit.

According to another aspect of the present invention, a server is provided that includes a storage unit for storing at least one program, a communication unit for communicating through a network, and at least one processor for executing the at least one program. The at least one program includes a command to receive at least one piece of character information from a device, a command to obtain keyword information corresponding to the at least one piece of character information, a command to obtain at least one piece of recommended schedule information selected from a plurality of domains, based on the keyword information, and a command to transmit the keyword information and the at least one piece of recommended schedule information to the device. The device automatically completes schedule information by using the keyword information and the at least one piece of recommended schedule information.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a block diagram illustrating a system for automatically completing schedule information, according to an embodiment of the present invention;

FIG. 2 is a block diagram illustrating a user device, according to an embodiment of the present invention;

FIG. 3 is a diagram illustrating a correlation between metadata included in schedule information classified according to multiple domains, according to an embodiment of the present invention;

FIG. 4 is a block diagram illustrating a processor of FIG. 2 in detail, according to an embodiment of the present invention;

FIG. 5 is a diagram of screens for describing a process of automatically completing schedule information, according to an embodiment of the present invention;

FIG. 6 is a diagram illustrating a relationship between character information to be input corresponding to the screens of FIG. 5, and completed keyword information and recommended schedule information having a correlation with the completed keyword information, according to an embodiment of the present invention;

FIG. 7 is a block diagram illustrating the processor of FIG. 2 in detail, according to another embodiment of the present invention;

FIG. 8 is a block diagram illustrating a recommended server of FIG. 1 in detail, according to an embodiment of the present invention;

FIG. 9 is a block diagram illustrating a processor of FIG. 8 in detail, according to an embodiment of the present invention;

FIG. 10 is a block diagram illustrating the processor of FIG. 8 in detail, according to another embodiment of the present invention;

FIG. 11 is a flowchart illustrating a method of forming a social graph performed by a social graph forming unit of FIG. 10, according to an embodiment of the present invention;

FIGS. 12A and 12B illustrate social graphs, according to an embodiment of the present invention;

FIGS. 13 and 14 are diagrams illustrating the indexing of metadata between nodes respectively in the social graphs of FIGS. 12A and 12B, shown in multiple domain forms, according to an embodiment of the present invention;

FIGS. 15A and 15B illustrate the updating of social graphs of FIGS. 12A and 12B, respectively, according to an embodiment of the present invention;

FIG. 16 is a diagram illustrating the updated social graph of FIG. 15A in a multiple domain form, according to an embodiment of the present invention;

FIG. 17 is a diagram illustrating screens for describing a process of automatically completing schedule information, according to another embodiment of the present invention;

FIG. 18 illustrates a social graph in a multiple domain form, which is updated according to schedule information completed according to the process of FIG. 17, according to an embodiment of the present invention;

FIG. 19 is a flowchart illustrating a method of completing schedule information, which is performed by a user device, according to an embodiment of the present invention;

FIG. 20 is a flowchart illustrating a method of completing schedule information, which is performed by a user device, according to another embodiment of the present invention;

FIG. 21 is a flowchart illustrating a method of completing schedule information, which is performed by a server, according to an embodiment of the present invention;

FIG. 22 is a flowchart illustrating a method of completing schedule information, which is performed between a user device and a server, according to an embodiment of the present invention;

FIG. 23 is a flowchart illustrating a method of completing schedule information, which is performed by a server, according to another embodiment of the present invention;

FIG. 24 is a flowchart illustrating in detail operation for forming a social graph in the method of FIG. 23, according to an embodiment of the present invention;

FIG. 25 is a flowchart illustrating a method of completing schedule information, which is performed between a user device and a server, according to another embodiment of the present invention; and

FIG. 26 is a diagram of a screen displaying recommended schedule information, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

While terms such as “first,” “second,” etc., may be used to describe various components, such components are not limited to the above terms. The above terms are used only to distinguish one component from another.

The terms used in describing the embodiments of the present invention are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

As used herein, the term “and/or” includes any and all combinations of one or more of the associated listed items. Expressions such as “at least one of,” when preceding a list of elements, modify the entire list of elements and do not modify the individual elements of the list.

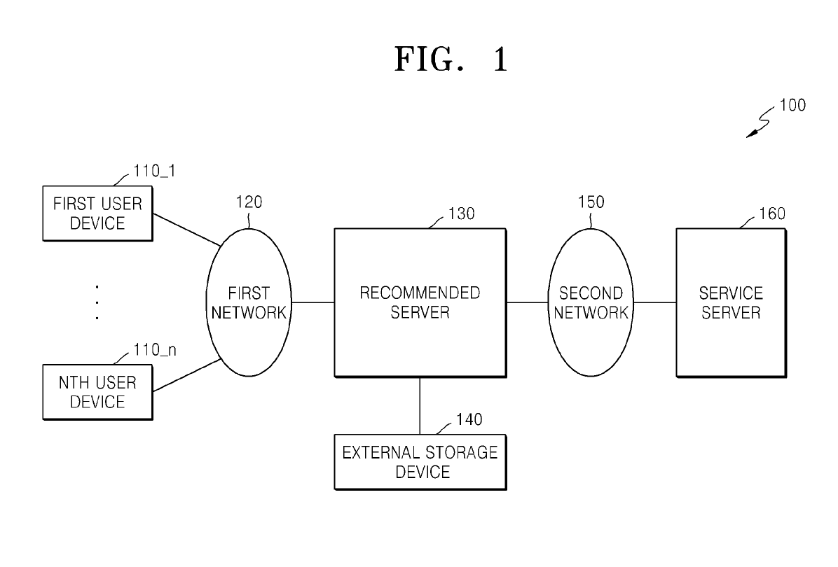

FIG. 1 is a block diagram of a system 100 for automatically completing schedule information, according to an embodiment of the present invention. The system 100 includes first through nth user devices 110_1 through 110_{—}n, a first network 120, a recommended server 130, an external storage device 140, a second network 150, and a service server 160.

However, the structure of the system 100 is not limited to that shown in FIG. 1. The first and second networks 120 and 150 are separately shown in FIG. 1 for convenience of description, but may be integrally formed according to a communication standard between the first through nth user devices 110_1 through 110_{—}n and the recommended server 130, and a communication standard between the recommended server 130 and the service server 160. The recommended server 130 and the service server 160 are separately shown in FIG. 1 in terms of functions, but may be formed as one server, and the external storage device 140 may be included in the recommended server 130. The system 100 of FIG. 1 may be understood as a diagram of a network for performing a method of automatically completing schedule information, according to an embodiment of the present invention.

Examples of the first through nth user devices 110_1 through 110_{—}n include, for example, a smart phone, a smart Television (TV), a PC, a desktop computer, a notebook computer, a tabletop computer, a smart board, a tablet PC, a slate PC, a digital photo frame, a mobile device, a handheld computer, a media player, and a Personal Digital Assistant (PDA), but are not limited thereto. The first through nth user devices 110_1 through 110_{—}n may also be referred to as a device or an apparatus.

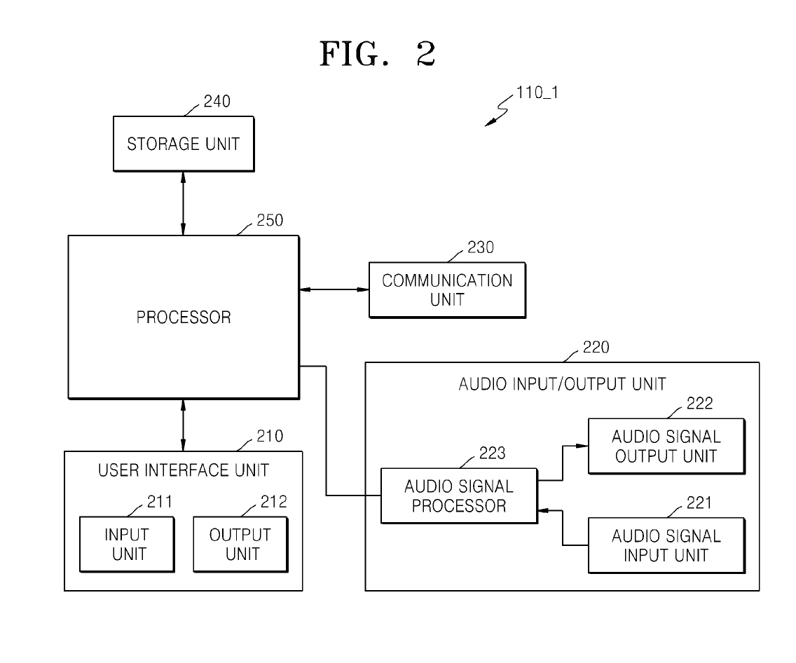

FIG. 2 is a block diagram illustrating the first user device 110_1 in detail, according to an embodiment of the present invention. The first user device 110_1 includes a user interface unit 210, an audio input/output unit 220, a communication unit 230, a storage unit 240, and a processor 250. The remaining user devices through 110_{—}n of FIG. 1 may be configured as the first user device 110_1 of FIG. 2.

However, the first through nth user devices 110_1 through 110_{—}n may include different elements. For example, if the first user device 110_1 is a smart phone and the nth user device 110_{—}n is a tablet PC, the first user device 110_1 may further include a camera module, whereas the nth user device 110_{—}n does not include a camera module. Such elements included in the first through nth user devices 110_1 through 110_{—}n are only examples, and thus, are not limited to those shown in FIG. 2. For convenience of description, a user device is described herein, with an example of the first user device 110_1, but the user device may be any one of the first through nth user devices 110_1 through 110_{—}n.

The user interface unit 210 provides an interaction or an interface between a user and the first user device 110_1, and may be referred to as a user interface. The user interface unit 210 includes an input unit 211 for receiving an input signal, and an output unit 212 for outputting an output signal. The input and output units 211 and 212 may be configured as individual elements. The user may input information, commands, instructions, or data by using the input unit 211. A signal transmitted or input from the input unit 211 to the processor 250 may be referred to as input information, an input command, an input instruction, or input data.

The input unit 211 may be configured based on a touch interface using a touch panel or a touch screen. If the input unit 211 is configured based on a touch interface, the input and output units 211 and 212 may have a combined structure. When the input and output units 211 and 212 have the combined structure based on a touch interface, the input unit 211 may transmit a signal indicating sensing of at least one of a touching operation and touching intensity of a finger or a stylus pen of a user on a screen displayed on the output unit 212, to the processor 250 as an input signal. The touching operation of the finger or stylus pen of the user includes a number of touches.

The input unit 211 may include a touch sensor so as to transmit the signal that sensed at least one of the touching operation and touching intensity of the finger or stylus pen to the processor 250. The input unit 211 may include at least one of a physical button, a switch, and a stick, and the touch interface described above. A touch using the finger of the user on the input unit 211 may be understood as a touch using a body of the user. The body of the user includes any body part that can touch a touch area of the input unit 211.

The input signal to be input through the input unit 211, according to an embodiment of the present invention, includes at least one piece of character information for automatically completing schedule information, and a signal that is for determining selection or selection and combination of at least one piece of recommended schedule information in multiple domains provided through the output unit 212. The multiple domains may be referred to as a plurality of domains. The signal that determines the selection or selection and combination of the recommended schedule information corresponds to clicking or touching of an OK button or a confirm button output to the output unit 212, or a physical OK button or confirm button.

The output unit 212 may include, for example, a Liquid Crystal Display (LCD), a Thin Film Transistor-Liquid Crystal Display (TFT-LCD), an Organic Light-Emitting Diode (OLED), a flexible display, a 3-Dimensional (3D) display, or an Active-Matrix Organic Light-Emitting Diode (AMO LED). Thus, the output unit 212 may be referred to as a display function unit or a display.

The audio input/output unit 220 provides an audio interface between the user and the first user device 110_1. The audio input/output unit 220 includes an audio signal input unit 221, such as a microphone, for receiving an audio signal, an audio signal output unit 222, such as a speaker, for outputting an audio signal, and an audio signal processor 223.

The audio signal input unit 221 converts a received audio signal to an electric signal, and transmits the electric signal to the audio signal processor 223. The audio signal processor 223 converts the electric signal received from the audio signal input unit 221 to audio data, and transmits the audio data to the processor 250. The processor 250 may store the audio data received from the audio signal processor 223 in the storage unit 240 or externally output the audio data through the communication unit 230. The storage unit 240 may store the audio data in a file form.

The processor 250 transmits audio data read from the storage unit 240 or received through the communication unit 230 to the audio signal processor 223. The audio signal processor 223 converts the audio data from the processor 250 to an electric signal, and transmits the electric signal to the audio signal output unit 222. The audio signal output unit 222 converts and outputs the received electric signal to a signal audible by the user. The audio signal input unit 221 and the audio signal output unit 222 may be integrally formed like a headset.

The communication unit 230 may transmit and receive a message or data to and from another apparatus through, for example, a wireless network, such as wired or wireless Internet, the Intranet, a cellular phone network, a Local Area Network (LAN), a Wi-Fi network, a 3rd Generation (3G) network, a 4th Generation (4G) Long Term Evolution (LTE) network, a Bluetooth network, a Radio Frequency IDentification (RFID) network, or a Zigbee network, or by using a plug and play interface, such as a Universal Serial Bus (USB) port. According to an embodiment of the present invention, the other apparatus includes the recommended server 130 constituting an external device of the first user device 110_1. If the recommended server 130 is a cloud server or a virtual server, the communication unit 230 may transmit and receive a message or data with the recommended server 130 by using one of the wired or wireless Internet, the 3G network, the Wi-Fi network, and the 4G LTE network.

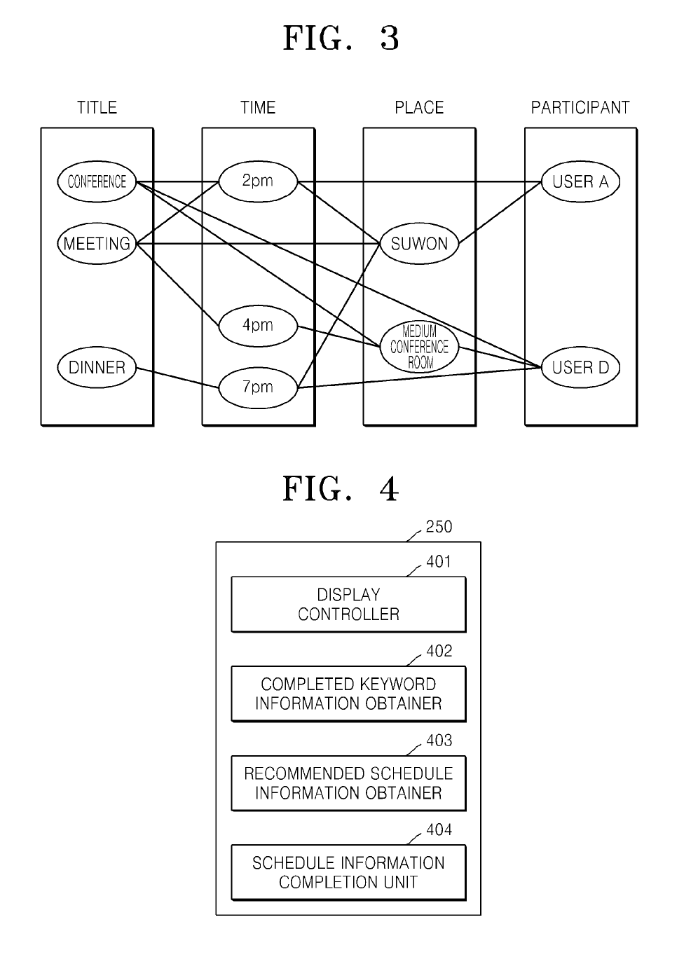

Data transmittable to the recommended server 130 through the communication unit 230 includes at least one piece of character information, input from the input unit 211 of the user interface unit 21,0 for automatic completion of schedule information, ID information of the user for connection to the service server 160, and password information. Data receivable from the recommended server 130 through the communication unit 230 includes at least one piece of completed keyword information corresponding to the at least one piece of character information, and at least one piece of recommended schedule information having a correlation with the at least one piece of completed keyword information. The completed keyword information corresponding to the character information input by the user, and the recommended schedule information related to the completed keyword information are described in detail below with reference to FIGS. 3, 5, and 6.

The storage unit 240 may include a non-volatile memory, such as a high speed Random Access Memory (RAM), a magnetic disc storage apparatus, or a flash memory, or a non-volatile semiconductor memory. The storage unit 240 may store at least one program and a resource for performing a method of completing schedule information, according to an embodiment of the present invention. The resource includes information required when the at least one program for performing the method is executed.

For example, if the program is not performed by being connected to the recommended server 130, but is configured to use schedule information stored in the first user device 110_1, the resource may include pre-stored schedule information and a database including at least one piece of completed keyword information parsed and extracted from the pre-stored schedule information, and at least one piece of recommended schedule information in multiple domains having a correlation with the at least one piece of completed keyword information. The multiple domains correspond to a number of categories for classifying metadata included in schedule information. In other words, a domain corresponds to one category, and when metadata included in schedule information is classified into N categories, the multiple domains include N domains. A program includes commands for performing a method of completing schedule information.

FIG. 3 is a diagram illustrating a correlation between metadata included in schedule information classified according to multiple domains, according to an embodiment of the present invention. The metadata included in the schedule information is classified into a title, a time, a place, and a participant. The database including the completed keyword information and the recommended schedule information having a correlation with the completed keyword information and stored in the storage unit 240 may be configured such that the metadata classified as in FIG. 3 is indexed.

When information included in the database stored in the storage unit 240 is indexed based on the correlation shown in FIG. 3, and completed keyword information is “conference” included in a title domain, and “2 pm” in a time domain and “user A” in a participant domain, which have correlations with “conference”, may be provided as recommended schedule information. The completed keyword information may be one of the pieces of metadata included in each domain. For example, the completed keyword information may be “2 pm” in the time domain, “Suwon” in a place domain, or “user A” in the participant domain.

If “2 pm” in the time domain is the completed keyword information, the recommended schedule information includes “conference” and “meeting” in the title domain, “Suwon” in the place domain, and “user A” in the participant domain. If “Suwon” in the place domain is the completed keyword information, the recommended schedule information includes “2 pm” and “7 pm” in the time domain and “user A” in the participant domain. If “user D” in the participant domain is the completed keyword information, the recommended schedule information includes “conference” in the title domain, “7 pm” in the time domain, and “medium conference room” in the place domain. The metadata included in each domain may be referred to as completed keyword information.

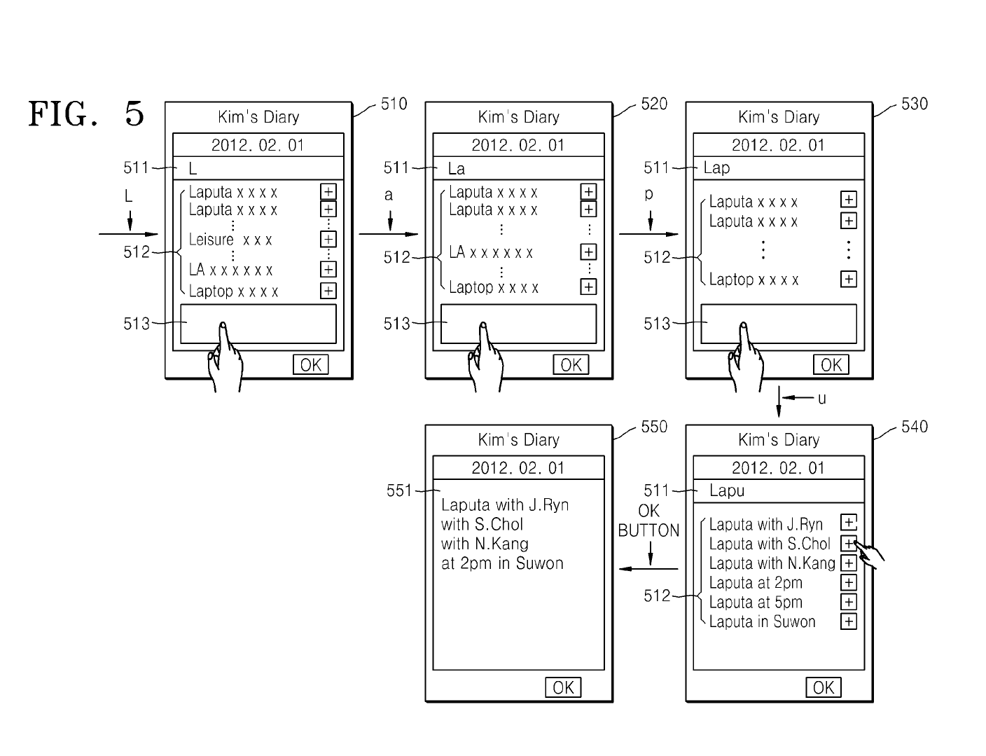

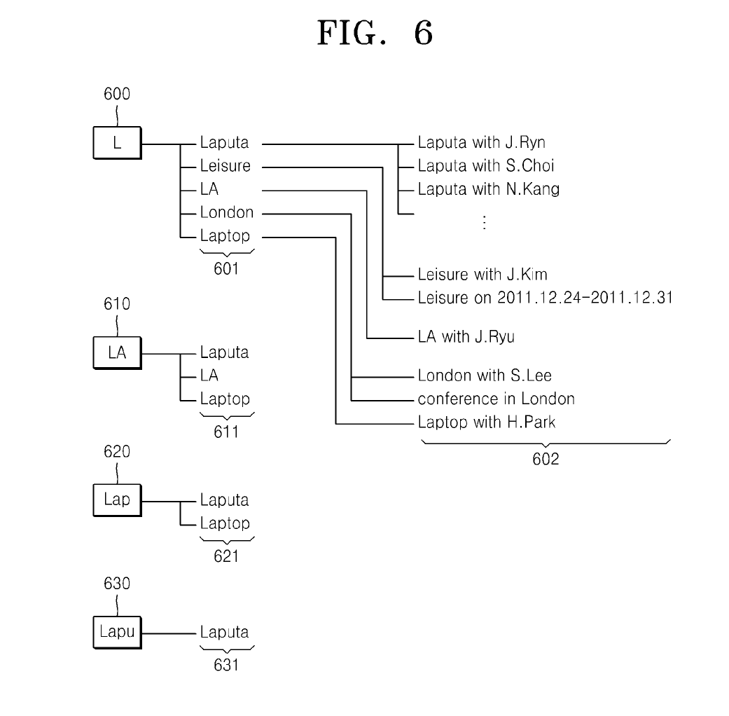

Multiple domains are not limited to those shown in FIG. 3. Specifically, other category information, such as weather information, may also be included as one domain. A relationship between the completed keyword information and the recommended schedule information in the multiple domains is described in detail below with reference to FIGS. 5 and 6.

The storage unit 240 may include a first storage unit for storing at least one program for performing a method, according to an embodiment of the present invention, and a resource required to execute the at least one program. The storage unit 240 may also include a second storage unit for storing a database including completed keyword information based on pre-stored schedule information and recommended schedule information in multiple domains having a correlation with the completed keyword information.

The processor 250 may be one or more processors for controlling all of the functions of the first user device 110_1. The processor 250 may be one or more processors because, although the processor 250 is shown in a single chip form in FIG. 2, the processor 250 may be operated after being divided into a plurality of processors, according to functions of the first user device 110_1.

The processor 250 may be embodied as a controller, a microprocessor, a digital signal processor, or the like. The processor 250 may operate based on an application for performing a method of completing schedule information, according to an embodiment of the present invention. A program for executing the application for performing the method may be read from the storage unit 240, or downloaded from an application store server, a market server, or an application providing server connected through the communication unit 230.

FIG. 4 is a block diagram illustrating the processor 250 of FIG. 2 in detail, according to an embodiment of the present invention. At least one piece of completed keyword information and at least one piece of recommended schedule information in multiple domains having a correlation with the completed keyword information, which are required to complete the schedule information, are obtained from the storage unit 240 included in the first user device 110_1.

Referring to FIG. 4, the processor 250 includes a display controller 401, a completed keyword information obtainer 402, a recommended schedule information obtainer 403, and a schedule information completion unit 404.

The display controller 401 displays screens according to the execution of an application for automatically completing schedule information, according to an embodiment of the present invention, on the output unit 212. For example, the display controller 401, in order to compete the schedule information, displays at least one piece of character information input by a user, completed keyword information corresponding to the character information, and at least one piece of recommended schedule information in multiple domains having a correlation with the completed keyword information on the output unit 212.

The completed keyword information obtainer 402 obtains completed keyword information corresponding to character information input from the input unit 211 from information stored in the storage unit 240. Whenever a piece of character information is input from the input unit 211, the completed keyword information obtainer 402 may read or detect completed keyword information including character information matching the input character information, from completed keyword information stored in the storage unit 240. The completed keyword information stored in the storage unit 240 includes all pieces of completed keyword information (metadata) included in multiple domains.

The completed keyword information obtainer 402 may read or detect from the storage unit 240 the completed keyword information corresponding to the input character information by matching the input character information sequentially from a first piece of character information to a last piece of character information in the completed keyword information. Alternatively, the completed keyword information obtainer 402 may read or detect from the storage unit 240 the completed keyword information corresponding to the input character information by matching the input character information sequentially from the last piece of character information to the first piece of character information in the completed keyword information. In embodiments of the present invention, the completed keyword information is read or detected via the former of the above two methods. However, a method of obtaining the completed keyword information corresponding to the input character information is not limited to the above two methods.

The recommended schedule information obtainer 403 reads or detects, from the storage unit 240, at least one piece of recommended schedule information having a correlation with the completed keyword information obtained by the completed keyword information obtainer 402, with respect to the metadata included in each of multiple domains stored in the storage unit 240. The at least one piece of recommended schedule information in the multiple domains is output to the output unit 212.

The schedule information completion unit 404 completes schedule information according to a selection operation or a selection and combination operation performed by the user on the recommended schedule information in the multiple domains output by the output unit 212.

Operations of the display controller 401, the completed keyword information obtainer 402, the recommended schedule information obtainer 403, and the schedule information completion unit 404 are described in detail below with reference to FIGS. 5 and 6.

FIG. 5 is a diagram of screens illustrating a process of automatically completing schedule information, according to an embodiment of the present invention. The processor 250 executes a schedule information completion application according to an embodiment of the present invention, and at least one piece of character information for automatically completing schedule information is input after designating a desired date, for example, Feb. 1, 2012, to input schedule information. FIG. 6 is a diagram illustrating a relationship between the character information to be input, and completed keyword information and recommended schedule information having a correlation with the completed keyword information, corresponding to the screens of FIG. 5.

When a user inputs character information “L” by using a region 513 of screen 510 included in a schedule information input execution window displayed on the output unit 212, the display controller 401 displays the character information “L” on an input window 511 of the screen 510. A virtual keyboard for inputting information is displayed or information is input by using a stylus pen at the region 513 in screen 510. However, the embodiments of the present invention are not limited thereto. At least one piece of completed keyword information obtained by the completed keyword information obtainer 402, and at least one piece of recommended schedule information having a correlation with the at least one piece of completed keyword information and obtained by the recommended schedule information obtainer 403, are displayed on a region 512 of the screen 510, according to the input character information “L”.

For example, referring to FIG. 6, when completed keyword information, including a character information “L” 600 as a first piece of character information, is obtained by the completed keyword information obtainer 402 as “Laputa, Leisure, LA, London, Laptop” as shown in a region 601, and recommended schedule information obtained by the recommended schedule information obtainer 403 is displayed as shown in a region 602, the recommended schedule information may be displayed in the region 512 of the screen 510 of FIG. 5, as shown in the region 602.

The recommended schedule information as shown in the region 602 of FIG. 6 is defined in a form expressing a correlation based on a determined rule, according to a domain including metadata having a correlation with completed keyword information and a domain including completed keyword information. For example, when the completed keyword information is “Laputa” included in a title domain, and metadata having a correlation with the completed keyword information is “J. Ryu” included in a participant domain, recommended schedule information about “J. Ryu” may be defined as “Laputa with J. Ryu”. Alternatively, when completed keyword information is “London” included in a place domain, and metadata having a correlation with the completed keyword information is “conference” included in a title domain, recommended schedule information about “conference” may be defined as “conference in London”.

However, a rule for defining recommended schedule information based on a correlation between a domain including metadata and a domain including completed keyword information is not limited to using a preposition, such as with, at, on, or in. The rule may be defined by using a symbol, such as *, #, /, or &. Metadata may be referred to as another piece of completed keyword information about the completed keyword information.

When the recommended schedule information displayed on the region 512 of the screen 510 of FIG. 5 exceeds a size of the region 512, the user may view provided recommended schedule information by using a touch-based scroll function.

When the user inputs “a” as next character information by using the region 513, the screen 510 displayed on the output unit 212 is changed to a screen 520 by the display controller 401. Specifically, character information displayed on the input window 511 of the screen 520 becomes “La” as also shown in a region 610 of FIG. 6. Thus, the completed keyword information obtained by the completed keyword information obtainer 402 is reduced to “Laputa, LA, and Laptop”, as shown in a region 611 of FIG. 6. Accordingly, the recommended schedule information obtained by the recommended schedule information obtainer 403 is changed to recommended schedule information having a correlation with “Laputa, LA, and Laptop”. Recommended schedule information displayed on the region 512 of the screen 520 corresponds to the recommended schedule information shown in the region 611, which has the correlation with the completed keyword information.

When the user inputs “p” as next character information by using the region 513 of FIG. 5, the screen 520 displayed on the output unit 212 is changed to a screen 530 by the display controller 401. The character information displayed on the input window 511 of the screen 530 becomes “Lap”, as also shown in a region 620 of FIG. 6. Thus, the completed keyword information obtained by the completed keyword information obtainer 402 is reduced to “Laputa and Laptop”, as shown in a region 621 of FIG. 6. The recommended schedule information obtained by the recommended schedule information obtainer 403 is changed to recommended schedule information having a correlation with “Laputa and Laptop”. Accordingly, the recommended schedule information displayed on the region 512 of the screen 530 corresponds to the recommended schedule information having the correlation with “Laputa and Laptop”.

When the user inputs “u” as next character information by using the region 513 of FIG. 5, the screen 530 displayed on the output unit 212 is changed to a screen 540 by the display controller 401. The character information displayed on the input window 511 of the screen 540 becomes “Lapu” as also shown in a region 630 of FIG. 6. Thus, only “Laputa” is left as the completed keyword information obtained by the completed keyword information obtainer 402 as shown in a region 631 of FIG. 6. Accordingly, the recommended schedule information obtained by the recommended schedule information obtainer 403 is changed to recommended schedule information having a correlation with “Laputa”. The recommended schedule information displayed on the region 512 of the screen 540 of FIG. 5 corresponds to the recommended schedule information having the correlation with “Laputa”.

When desired schedule information is selected by touching or clicking a (+) icon displayed at the right of the recommended schedule information displayed on the region 512 of the screen 540, and an OK button is touched or clicked, the recommended schedule information selected by the schedule information completion unit 404 is combined to generate completed schedule information. When the completed schedule information is generated, the display controller 401 changes the screen 540 displayed on the output unit 212 to a screen 550. Information displayed on a region 551 of the screen 550 of FIG. 5 is schedule information automatically completed, according to at least one piece of input character information.

The (+) icon displayed on the right of the recommended schedule information displayed on the region 512 of the screens 510 through 540 is used to select recommended schedule information. An icon used to select recommended schedule information is not limited to the (+) icon. Thus, the user may select or select and combine recommended schedule information in any one of the screens 510 through 540. Also, since completed keyword information corresponding to character information, and recommended schedule information are provided whenever one piece of character information is input, the one piece of character information may be considered as one event or seed for automatic completion of schedule information. Accordingly, the application for performing the method may be referred to as a quick event.

When the schedule information is automatically completed, the processor 250 parses the metadata included in the completed schedule information according to domains, and updates schedule management information and the database for automatic completion of the schedule information stored in the storage unit 240 based on the parsed results. The schedule management information and the database stored in the storage unit 240 include the newly completed schedule information, and the correlation between metadata in the database may be changed.

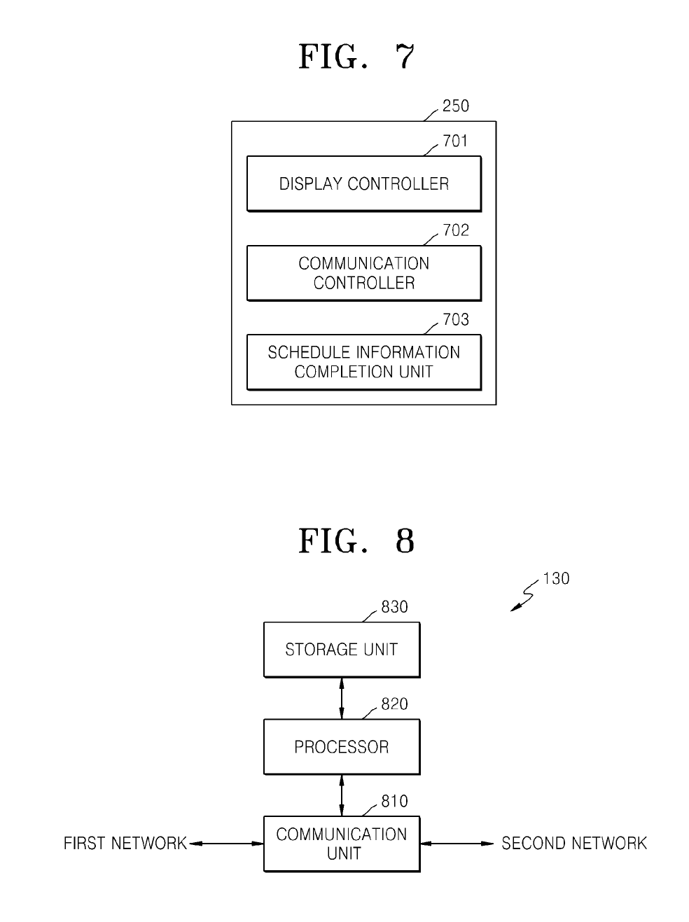

FIG. 7 is a block diagram illustrating the processor 250 of FIG. 2 in detail, according to another embodiment of the present invention. Completed keyword information and recommended schedule information in multiple domains are provided from the recommended server 130 and output to the output unit 212. Referring to FIG. 7, the processor 250 includes a display controller 701, a communication controller 702, and a schedule information completion unit 703.

The display controller 701 and the schedule information completion unit 703 respectively operate in the same manner as the display controller 401 and the schedule information completion unit 404 of FIG. 4. The communication controller 702 transmits one piece of character information to the recommended server 130 whenever the one piece of character information is input through the input unit 211, receives completed keyword information and recommended schedule information in multiple domains having a correlation with the completed keyword information from the recommended server 130, and transmits the completed keyword information and the recommended schedule information to the output unit 212 to be displayed. Details about the inputting of the character information, and the displaying of the completed keyword information corresponding to the input character information and the recommended schedule information having the correlation with the completed keyword information are described above with reference to FIGS. 5 and 6.

The processor 250 may be realized to include all elements shown in FIGS. 4 and 7. Specifically, the processor 250 may include the display controller 401, the completed keyword information obtainer 402, the recommended schedule information obtainer 403, the schedule information completion unit 404, and the communication controller 702. Accordingly, the processor 250 may receive completed keyword information corresponding to input character information, and recommended schedule information in multiple domains having a correlation with the completed keyword information from the storage unit 240 and the recommended server 130, displays all information excluding overlapping information from among the received completed keyword information and recommended schedule information on the output unit 212, and automatically completes schedule information as a selection or combination operation is performed based on the displayed information.

When the schedule information is automatically completed as such, a database related to schedule information and completed schedule information stored in the storage unit 240, and a database related to schedule information and completed schedule information stored in the recommended server 130 are updated according to the automatically completed schedule information. When the recommended server 130 provides completed keyword information and recommended schedule information having a correlation with the completed keyword information based on schedule information received from the service server 160 connected through the second network 150, the recommended server 130 may transmit completed schedule information received from the first user device 110_1 to the service server 160 so as to update schedule information stored in the service server 160.

The first and second networks 120 and 150 of FIG. 1 may be wired or wireless networks as described with reference to the communication unit 230.

The recommended server 130 of FIG. 1 recommends information for completing schedule information according to an embodiment of the present invention, and may be a cloud server or a virtual server. Recommended information includes completed keyword information corresponding to at least one piece of character information input by a user, and at least one piece of recommended schedule information in multiple domains having a correlation with the completed keyword information. The completed keyword information corresponding to the at least one piece of input character information, and the at least one piece of recommended schedule information in the multiple domains having the correlation with the completed keyword information are as described above with reference to FIGS. 5 and 6.

FIG. 8 is a block diagram illustrating the recommended server 130 of FIG. 1 in detail, according to an embodiment of the present invention. Referring to FIG. 8, the recommended server 130 includes a communication unit 810, a processor 820, and a storage unit 830. The communication unit 810 may communicate with the first through nth user devices 110_1 through 110_{—}n through the first network 120, and may communicate with the service server 160 through the second network 150. Accordingly, the communication unit 810 may be configured according to a communication standard of the first network 120 and a communication standard of the second network 150.

The processor 820 may include one or more processors that execute a method of completing schedule information, according to an embodiment of the present invention. Although the processor 820 is shown in a single chip form, like the processor 250 of FIG. 2, the processor 820 may include one or more processors because the processor 820 may be divided into and operated in a plurality of processors according to functions of the recommended server 130.

The processor 820 may be embodied as a controller, a microprocessor, or a digital signal processor. The processor 820 may operate based on an application for performing a method of completing schedule information, according to an embodiment of the present invention. A program for executing the application for performing the method may be read from the storage unit 830 or the external storage device 140, or downloaded from an application store serveror an application providing server connected through the communication unit 810. The program for executing the application includes commands for performing the method.

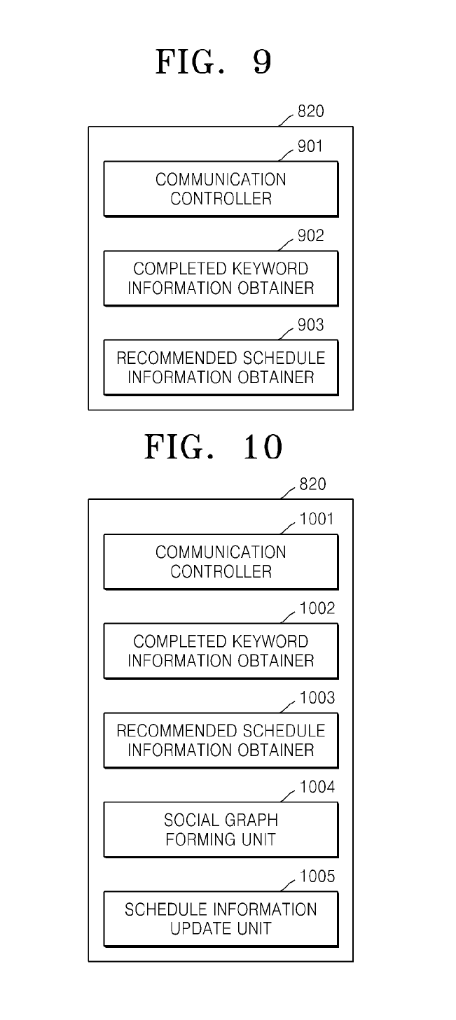

FIG. 9 is a block diagram illustrating the processor 820 of FIG. 8 in detail, according to an embodiment of the present invention. Completed keyword information and recommended schedule information are obtained by using information stored in the storage unit 830 or the external storage device 140. Referring to FIG. 9, the processor 820 includes a communication controller 901, a completed keyword information obtainer 902, and a recommended schedule information obtainer 903.

The communication controller 901 controls transmission and reception of information between the first through nth user devices 110_1 through 110_{—}n and the processor 820, through the communication unit 810. The completed keyword information obtainer 902 reads or detects, from the storage unit 830 and/or the external storage device 140, completed keyword information corresponding to at least one piece of character information received from at least one of the first through nth user devices 110_1 through 110_{—}n, through the communication unit 810.

The recommended schedule information obtainer 903 reads or detects recommended schedule information in multiple domains having a correlation with the completed keyword information, from the storage unit 830 and/or the external storage device 140, based on the read or detected completed keyword information. The completed keyword information corresponding to one piece of character information, and the recommended schedule information in the multiple domains having the correlation with the completed keyword information have a relationship as shown in FIGS. 5 and 6.

The external storage device 140 is configured to include a storage medium, such as a disk or a memory, and may be connected to the recommended server 130 via a wire or a wired network or wireless network, such as the Internet.

The storage unit 830 and the external storage device 140 may store the at least one program and the resource described above with reference to the storage unit 240 of FIG. 2.

FIG. 10 is a block diagram illustrating the processor 820 of FIG. 8 in detail, according to another embodiment of the present invention. The processor 820 forms a social graph based on a user who inputs at least one piece of character information, obtains and transmits completed keyword information and recommended schedule information based on the social graph to a user device, and updates schedule information of the user based on schedule automatic completion information received from the user device. The forming of the social graph may be referred to as the generation of the social graph.

Referring to FIG. 10, the processor 820 includes a communication controller 1001, a completed keyword information obtainer 1002, a recommended schedule information obtainer 1003, a social graph forming unit 1004, and a schedule information update unit 1005.

Communication control functions of the communication controller 1001, other than communication control with the first through nth user devices 110_1 through 110_{—}n through the first network 120 and communication control with the service server 160 through the second network 150 for forming a social graph, are identical to those of the communication controller 901 of FIG. 9.

The completed keyword information obtainer 1002 and the recommended schedule information obtainer 1003 are respectively identical to the completed keyword information obtainer 902 and the recommended schedule information obtainer 903 of FIG. 9.

The social graph forming unit 1004 forms a social graph based on social network information and schedule information collected from the service server 160 through the second network 150.

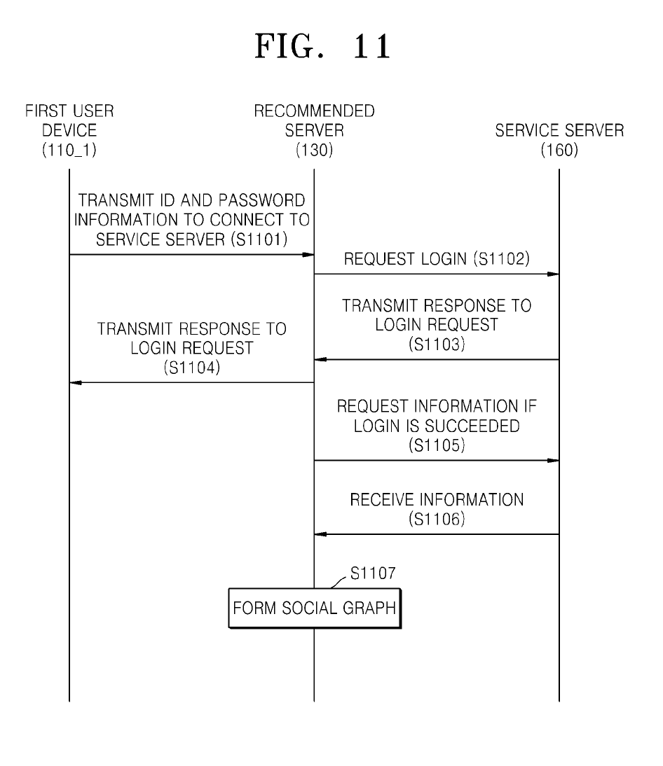

FIG. 11 is a flowchart illustrating a method of forming a social graph performed by the social graph forming unit 1004 of FIG. 10, according to an embodiment of the present invention. Referring to FIG. 11, the first user device 110_1 transmits ID information and password information to the recommended server 130 to connect to the service server 160, in step S1101. When the recommended server 130 receives the ID and password information, the communication controller 1001 of the recommended server 130 requests login to the service server 160 by using the received ID and password information, in step S1102. A response to the login request is received at the recommended server 130 from the service server 160, in step S1103. The communication controller 1001 of the recommended server 130 transmits the response to the first user device 110_1, in step S1104.

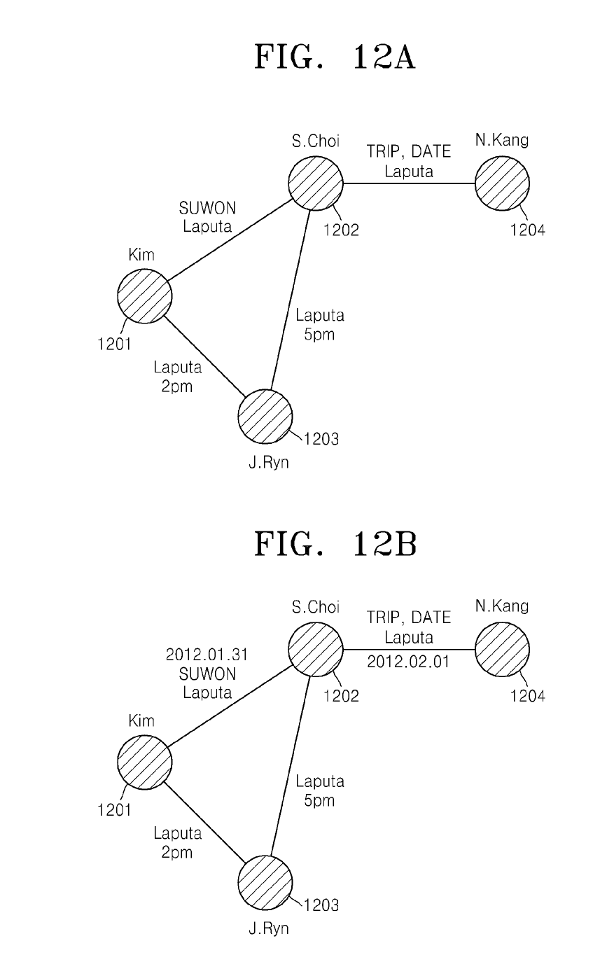

When the login has succeeded via this login process, the first user device 110_1 receives a desired service from the service server 160, and the communication controller 1001 of the recommended server 130 requests schedule information and social information of the first user device 110_1 or a user using the first user device 110_1 from the service server 160, in step S1105. The schedule information and the social information are received at the recommended server 130 from the service server 160, in step S1106. The social graph forming unit 1004 of the recommended server 130 parses the received schedule information and social information, and forms a social graph, in step S1107, by classifying metadata included in the schedule information and social information according to domains as described above with reference to FIG. 3. The classifying according to domains may be considered classifying according to categories. The social graph may not include date information as shown in FIG. 12A or may include date information as shown in FIG. 12B.

FIGS. 12A and 12B are diagrams illustrating examples of social graphs, according to embodiments of the present invention. Reference numerals 1201 through 1204 in FIGS. 12A and 12B are nodes on the social graphs, lines connecting each of the nodes 1201 through 1204 are links or social paths, and information written on each link is completed keyword information constituting metadata. The nodes 1201 through 1204 may be people or services used or required during a schedule, and in FIGS. 12A and 12B, the nodes 1201 through 1204 are people. The nodes 1202 and 1203 may be an acquaintance of the node 1201, or a member in a social group of the node 1201. Also, the node 1204 may be an acquaintance of the node 1202 or a member in a social group of the node 1202.

Metadata constituting completed keyword information having a correlation with the link between the nodes 1201 and 1202 is “Suwon” and “Laputa.” “Suwon” is included in a place domain and “Laputa” is included in a title domain. Completed keyword information having a correlation with the link between the nodes 1201 and 1203 is “Laputa” and “2 pm”. “Laputa” is included in the title domain and “2 pm” is included in a time domain. Metadata written on the other links of FIG. 12A may be understood in the same manner, and metadata written on each link between the nodes 1201 through 1204 of FIG. 12B may also be understood in the same manner.

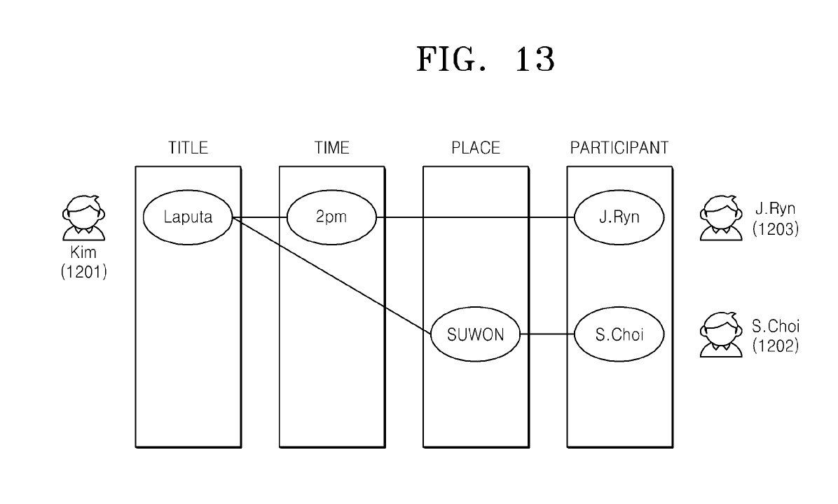

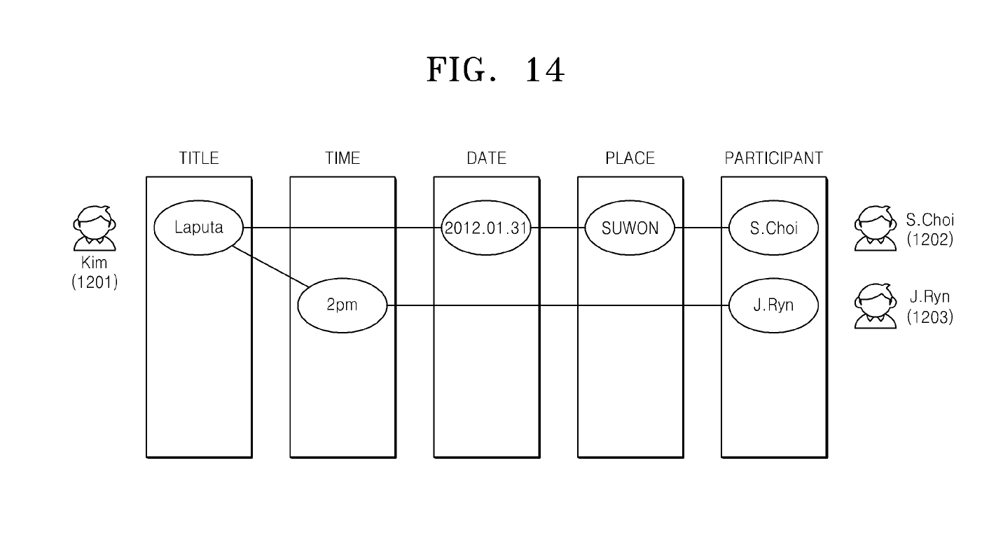

FIG. 13 is a diagram illustrating the indexing of metadata between the node 1201 and the nodes 1202 and 1203 in the social graph of FIG. 12A, shown in a multiple domain form of FIG. 3, according to an embodiment of the present invention. FIG. 14 is a diagram illustrating the indexing of metadata between the node 1201 and the nodes 1202 and 1203 in the social graph of FIG. 12B, shown in the multiple domain form of FIG. 3, according to an embodiment of the present invention.

Social graph-based information formed by the social graph forming unit 1004 is stored in the storage unit 830 or the external storage device 140, and is used when obtaining completed keyword information and recommended schedule information in multiple domains having a correlation with the completed keyword information.

Upon receiving schedule information that was automatically completed by the first user device 110_1, the schedule information update unit 1005 parses the schedule information to update the social graph-based information stored in the storage unit 830 or the external storage device 140, or transmits the automatically completed schedule information to the service server 160.

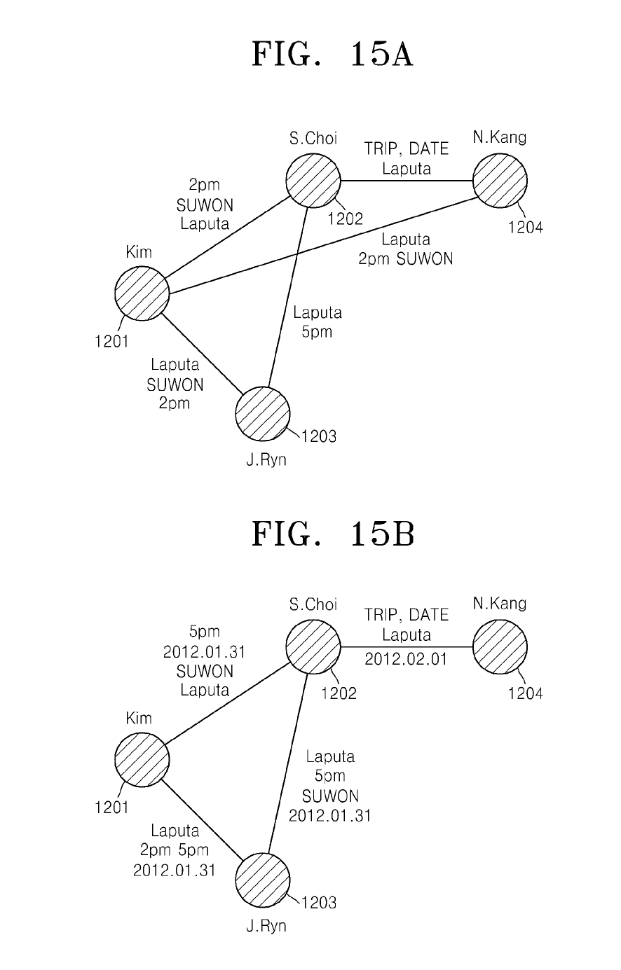

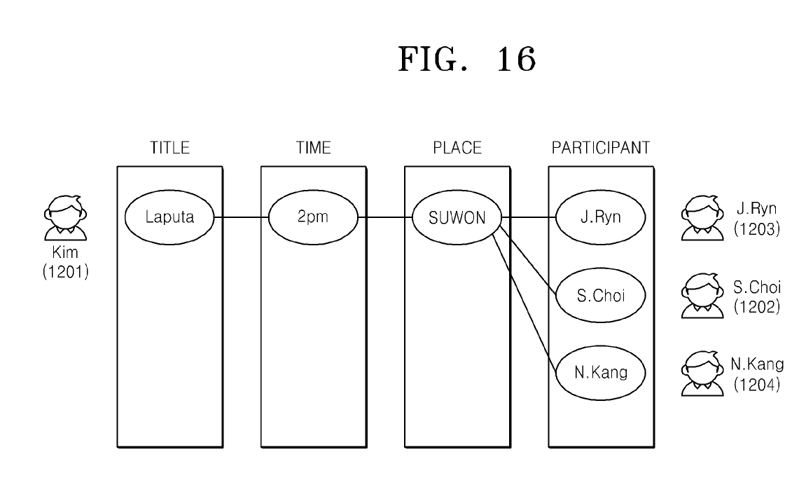

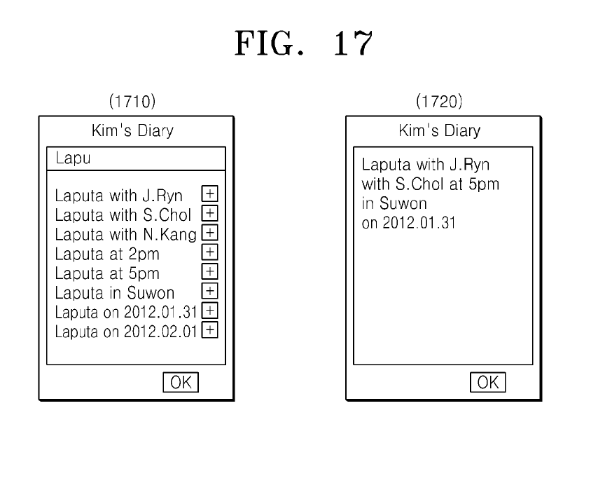

When the automatically completed schedule information received from the first user device 110_1 is as shown in the region 551 of FIG. 5, the social graph of FIG. 12A is updated as shown in FIG. 15A, and the indexing of metadata shown in FIG. 13 is updated as shown in FIG. 16.

When date information is included in the social graph-based information as shown in FIG. 12B, a desired date is not pre-designated when an application for performing a method of automatically completing schedule information, according to an embodiment of the present invention, is executed by the first user device 110_1.

FIG. 17 is a diagram illustrating screens 1710 and 1720 for describing a process of automatically completing schedule information, according to another embodiment of the present invention. The embodiment of FIG. 17 is based on completed keyword information corresponding to input character information, and recommended schedule information having a correlation with the completed keyword information, which correspond to the screens 540 and 550 of FIG. 5, if date information is not pre-designated.

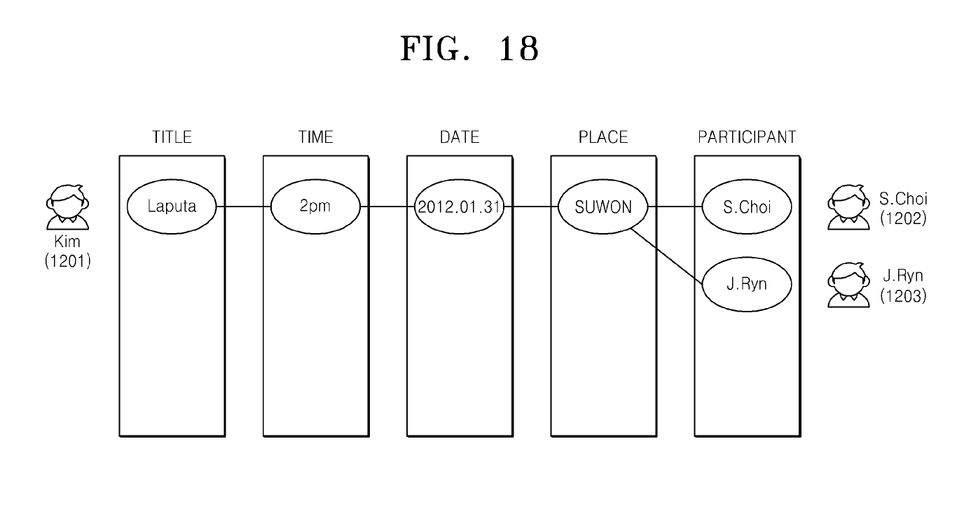

Accordingly, when input character information becomes “Lapu”, as shown in the screen 540 when one piece of character information is input as shown in FIG. 5, the screen 1710 of FIG. 17 is shown on the output unit 212. When schedule information completed according to a selection operation and control of an OK button by the user is displayed as shown in the screen 1720, the social graph of FIG. 12B is updated as shown in FIG. 15B and the correlation between metadata shown in FIG. 14 is updated as shown in FIG. 18.

Structures of the social graphs are individually shown in FIGS. 12A and 12B to aid in the understanding of an embodiment of the present invention. However, a social graph may be configured such that all metadata having correlations with nodes is connected to links between the nodes as shown in FIG. 12B. Completed keyword information and recommended schedule information having a correlation with the completed keyword information may be obtained from all of the metadata connected to the links between the nodes.

The service server 160 of FIG. 1 may include at least one of a web service server, such as a Google calendar service server, and a social network service server.

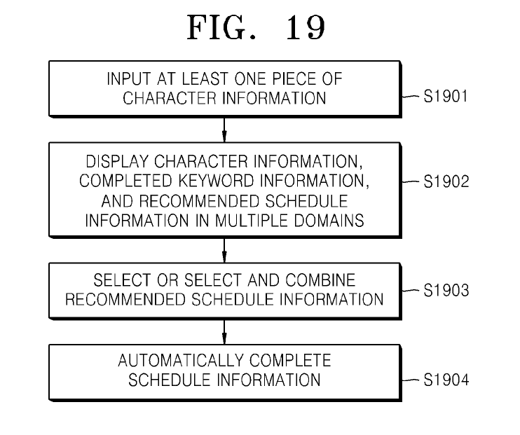

FIG. 19 is a flowchart illustrating a method of completing schedule information, which is performed by the first user device 110_1, according to an embodiment of the present invention. Schedule information stored in the first user device 110_1 is used. The processor 250 of FIG. 2 may operate according to the method of FIG. 19.

Referring to FIG. 19, the user interface unit 210 inputs at least one piece of character information, in step S1901. The processor 250 displays the input character information, at least one piece of completed keyword information corresponding to the input character information, and at least one piece of recommended schedule information in multiple domains, having a correlation with the at least one piece of completed keyword information, on the user interface unit 210, in step S1902. The completed keyword information and the recommended schedule information are displayed as described above with reference to FIGS. 5 and 6. The at least one piece of completed keyword information and the at least one piece of recommended schedule information, in the multiple domains, having the correlation with the completed keyword information, are based on schedule information stored in the storage unit 240.

When a selection operation or a selection and combination operation is performed on recommended schedule information displayed on the user interface unit 210 in step S1903, the processor 250 automatically completes schedule information in step S1904. A combination operation performed on the recommended schedule information denotes a selection operation performed on a plurality of pieces of recommended schedule information. The schedule information that is automatically completed has a format as shown in the region 551 of the screen 550 of FIG. 5.

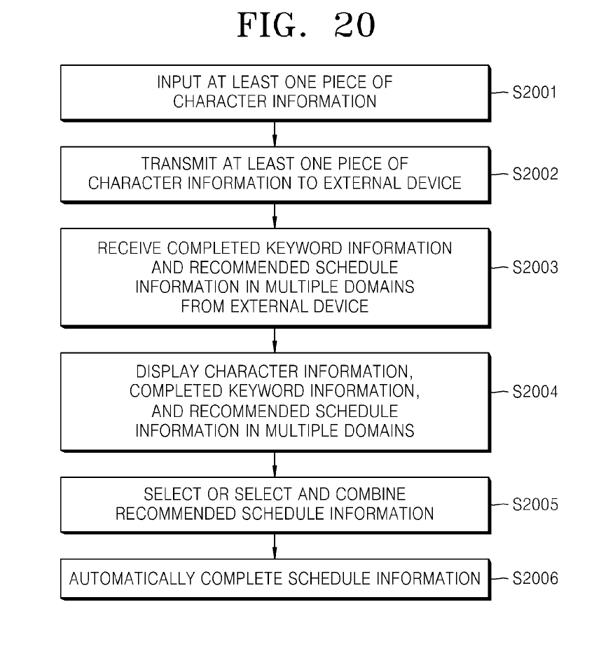

FIG. 20 is a flowchart illustrating a method of completing schedule information, which is performed by the first user device 110_1, according to another embodiment of the present invention. The recommended server 130 provides completed keyword information and recommended schedule information in multiple domains. The processor 250 of FIG. 2 may operate according to the method of FIG. 20.

Referring to FIG. 20, at least one piece of character information is input by the user interface unit 210, in step S2001. The processor 250 transmits the at least one piece of character information to the recommended server 130 constituting an external device through the communication unit 230, in step S2002.

At least one piece of completed keyword information corresponding to the at least one piece of character information, and at least one piece of recommended schedule information, in multiple domains having a correlation with the at least one piece of completed keyword information, are received from the recommended server 130 through the communication unit 230, in step S2003. The processor 250 displays the inputted character information, the received completed keyword information, and the received recommended schedule information in the multiple domains, on the user interface unit 210, in step S2004. The completed keyword information corresponding to the input character information, and the recommended schedule information in the multiple domains, having the correlation with the completed keyword information, are displayed as described above with reference to FIGS. 5 and 6.

A selection operation or a selection and combination operation is performed on the recommended schedule information displayed on the user interface unit 210, in step S2005. The processor 250 automatically completes schedule information, in step S2006. The schedule information that is automatically completed has a format as shown in the region 551 of the screen 550 in FIG. 5.

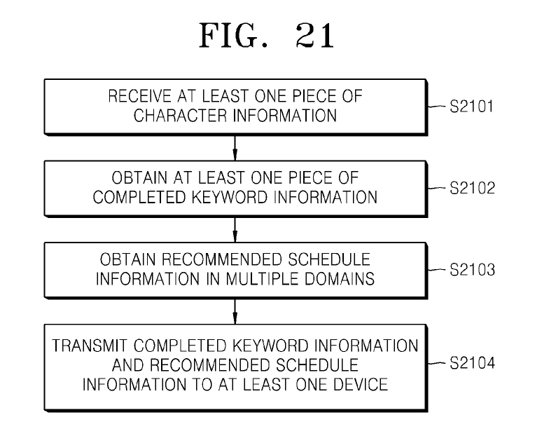

FIG. 21 is a flowchart illustrating a method of completing schedule information, which is performed by the recommended server 130, according to an embodiment of the present invention. The recommended server 130 performs the method of FIG. 21 when the first user device 110_1 performs the method of FIG. 20. Also, the method of FIG. 21 is performed such that recommended information based on schedule information stored in the storage unit 830 of the recommended server 130 or the external storage device 140 is provided to the first user device 110_1.

The processor 820 of FIG. 8 may operate according to the method of FIG. 21. Referring to FIG. 21, the processor 820 receives at least one piece of character information from the first user device 110_1 through the communication unit 810, in step S2101. The processor 820 obtains at least one piece of completed keyword information from schedule information stored in the storage unit 830 and/or the external storage device 140, in step S2102.

The processor 820 obtains recommended schedule information in multiple domains having a correlation with the obtained completed keyword information from the schedule information stored in the storage unit 830 and/or the external storage device 140, in step S2103.

The processor 820 transmits the at least one piece of completed keyword information and the recommended schedule information in the multiple domains, having the correlation with the completed keyword information, to the first user device 110_1 through the communication unit 810, in step S2104.

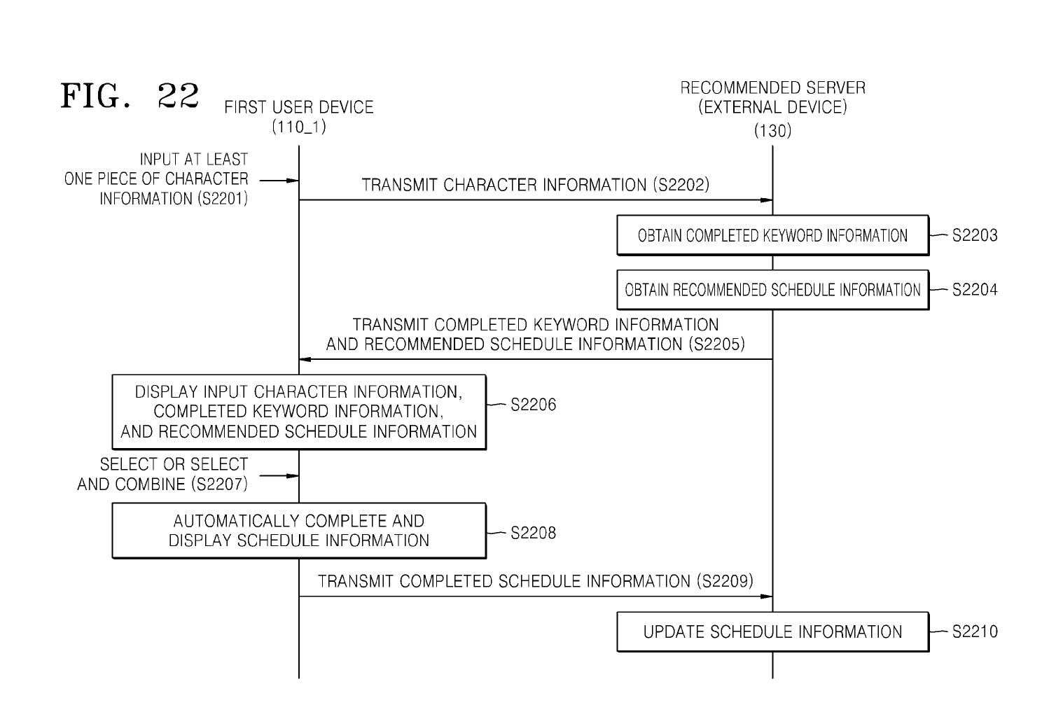

FIG. 22 is a flowchart illustrating a method of completing schedule information, which is performed between the first user device 110_1 and the recommended server 130, according to the method of FIG. 20 and the method of FIG. 21, according to an embodiment of the present invention.

At least one piece of character information for completing schedule information is input to the first user device 110_1, in step S2201. The first user device 110_1 transmits the character information to the recommended server 130 constituting an external device, in step

S2202. Accordingly, the recommended server 130 receives at least one piece of completed keyword information, including the received character information, from the storage unit 830 and/or the external storage device 140, in step S2203. The recommended server 130 receives recommended schedule information having a correlation with the obtained at least one piece of completed keyword information from the storage unit 830 and/or the external storage device 140, in step S2204.

The recommended server 130 transmits the completed keyword information and the recommended schedule information to the first user device 110_1, in step S2205. Accordingly, the first user device 110_1 displays the character information input in step S2201, the received at least one piece of completed keyword information, and the recommended schedule information in multiple domains, in step S2206. The displayed completed keyword information and recommended schedule information in the multiple domains may be referred to as a recommended schedule information list in a combined or completed form, as shown in the region 512 of FIG. 5. Steps S2201 through S2206 are performed whenever one piece of character information is input until the inputting of character information for completing schedule information is completed, by using the first user device 110_1. The completed keyword information and the recommended schedule information in the multiple domains, displayed on the first user device 110_1, are displayed in a combined form according to a determined rule, as shown in the region 512 of the screens 510 through 540 of FIG. 5.

The recommended schedule information is selected, or selected and combined, in step S2207 based on information displayed on the first user device 110_1. The first user device 110_1 automatically completes the schedule information and displays the completed schedule information, as shown in the screen 550 of FIG. 5, in step S2208. The first user device 110_1 transmits the completed schedule information to the recommended server 130, in step S2209. Accordingly, the recommended server 130 updates schedule information stored in the storage unit 830 and/or the external storage device 140 by using the received completed schedule information, in step S2210.

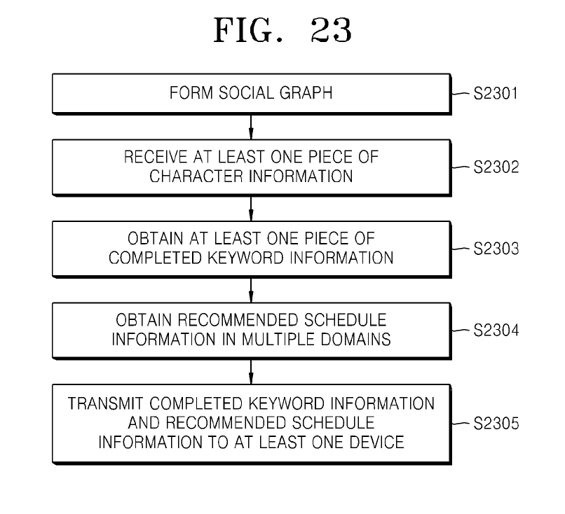

FIG. 23 is a flowchart illustrating a method of completing schedule information, which is performed by the recommended server 130, according to another embodiment of the present invention. The method is performed by the recommended server 130 when the first user device 110_1 operates according to the method of FIG. 20.

The processor 820 of FIG. 8 may operate according to the method of FIG. 23. Referring to FIG. 23, the processor 820 forms a social graph of the first user device 110_1, or a user using the first user device 110_1, in step S2301.

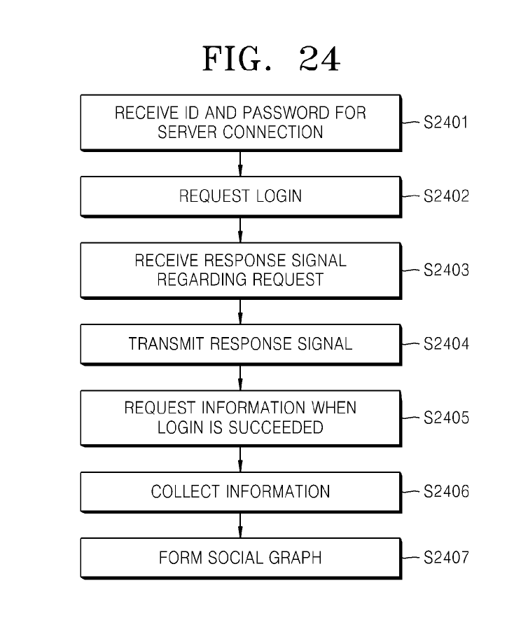

FIG. 24 is a flowchart illustrating step S2301 of FIG. 23 in detail. Referring to FIG. 24, an ID and a password for server connection are received from the first user device 110_1, in step S2401. The processor 820 requests login to the service server 160, in step S2402. A response signal regarding the request is received from the service server 160, in step S2403. The recommended server 130 transmits the response signal to the first user device 110_1, in step S2404. When the login request of the first user device 110_1 succeeds, the recommended server 130 requests, from the service server 160, schedule information and social information of the first user device 110_1 or the user using the first user device 110_1, in step S2405. The schedule information and social information of the first user device 110_1 or the user using the first user device 110_1 are collected from the service server 160, in step S2406. The collected information is parsed to form a social graph, in step S2407.

Referring back to FIG. 23, when the social graph is formed in step S2301, the processor 820 performs steps S2302 through S2305 that are respectively identical to operations S2101 through S2104 of FIG. 21.

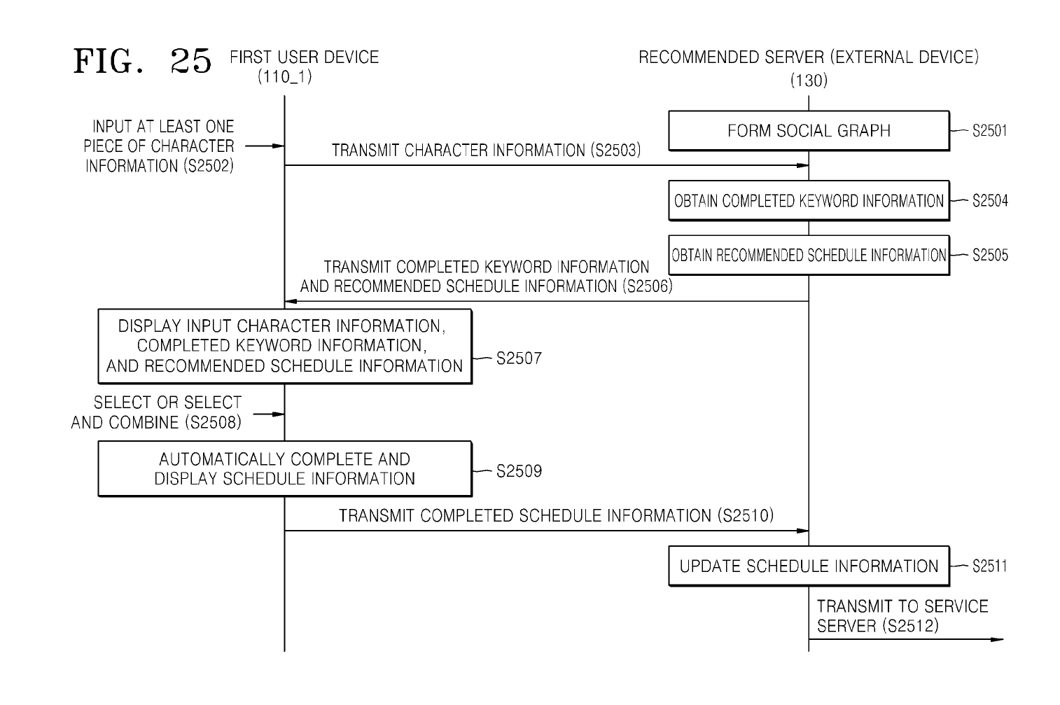

FIG. 25 is a flowchart illustrating a method of completing schedule information, which is performed between the first user device 110_1 and the recommended server 130, according to an embodiment of the present invention illustrated in FIGS. 20 and 23. The method of FIG. 25 is similar to the method of FIG. 22, except that at least one piece of completed keyword information and recommended schedule information in multiple domains, having a correlation with the completed keyword information, which are provided to the first user device 110_1, are provided based on social graph-based information. Thus, details about steps S2502 through S2510 of FIG. 25 are not described herein as they are respectively identical to steps S2201 through S2209 of FIG. 22.

The recommended server 130 forms a social graph in step S2501, as described with reference to the method of FIG. 24. The recommended server 130 updates social graph-based information, in step S2511, by parsing the completed schedule information, and transmits the completed schedule information to the service server 160, in step S2512.

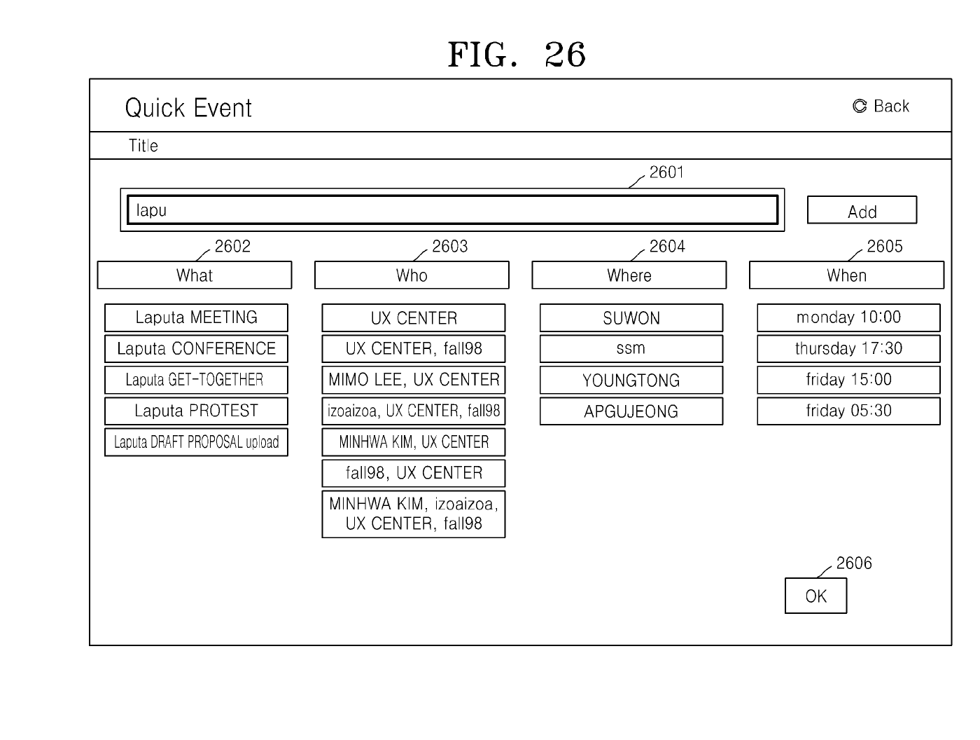

FIG. 26 is a diagram of a screen displaying recommended schedule information, according to an embodiment of the present invention. The screen is based on a recommended information list classified according to domains. The recommended information list may be based on completed keyword information according to domains. The recommended information list may be referred to as a recommended schedule information list.

A recommended schedule information list having a form where completed keyword information including input character information and another piece of completed keyword information are combined is displayed in FIGS. 5 and 17. However, in FIG. 26, a recommended information list according to domains having a correlation with completed keyword information, including input character information, is displayed. Schedule information is completed by automatically combining recommended information selected according to a selection operation of a user, based on the displayed recommended information list.

A recommended information list, classified according to domains, is displayed whenever a user inputs one piece of character information, as shown in FIG. 5, through a character information input window 2601 of FIG. 26. The displayed recommended information list is based on completed keyword information having a correlation with completed keyword information including the character information input to the character information input window 2601. Accordingly, the recommended information lists, based on a what domain 2602, a who domain 2603, a where domain 2604, and a when domain 2605 of FIG. 26, are based on completed keyword information having a correlation with completed keyword information including “Lapu” input on the character information input window 2601.

When a selection operation based on touching or clicking is performed by the user on the displayed recommended information list according to domains, selected recommended information is combined to automatically complete schedule information. For example, the user may touch or click “Laputa conference” from a completed keyword information list displayed on the what domain 2602, touch or click each of “UX center” and “Mimo Lee, UX center” from a completed keyword information list displayed on the who domain 2603, touch or click “Monday 10:00” from a completed keyword information displayed on the when domain 2605, and touch or click an OK button 2606 to complete the selection operation. Schedule information is completed by automatically combining the touched or clicked recommended information from the what, who, and when domains 2602, 2603, and 2605. The schedule information based on the selected recommended information may be completed according to a rule based on a pre-set domain in a form displayed on the region 551 of the screen 550 of FIG. 5. The completing of the selection operation is not limited to controlling the OK button 2606.

In the current embodiment of the present invention, recommended information displayed on the where domain 2604 is not selected so as to demonstrate for the purpose of description that there may be a domain from which the user does not select recommended information. Accordingly, when the screen of FIG. 26 is displayed, the user may select at least one piece of recommended information displayed on at least one domain from among displayed domains.

The recommended information list, according to domains shown in FIG. 26, may include metadata according to domains or completed keyword information according to domains. Accordingly, recommended information according to domains may be metadata or completed keyword information according to domains. Also, in the above embodiments of the present invention, completed keyword information may be referred to as keyword information.

The methods according to the embodiments of the present invention can also be embodied as computer readable codes on a computer readable recording medium. The computer readable recording medium is any data storage device that can store data, which can be thereafter read by a computer system. Examples of the computer readable recording medium include Read-Only Memory (ROM), Random-Access Memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been shown and described with reference to certain embodiments thereof, it will be understood by those of ordinary skill in the art that various changes in form and detail may be made therein without departing from the spirit and scope of the invention as defined by the appended claims. The embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of completing schedule information, which is performed by a device, the method comprising the steps of:
displaying, on the device, keyword information corresponding to at least one piece of character information, and at least one piece of recommended schedule information selected from a plurality of domains and having a correlation with the keyword information, in response to inputting the at least one piece of character information; and
automatically completing schedule information according to at least a selection of a piece of recommended schedule information from the displayed at least one piece of recommended schedule information.

2. The method of claim 1, wherein the keyword information and the at least one piece of recommended schedule information are based on pre-stored schedule information.

3. The method of claim 1, further comprising:
transmitting the at least one piece of character information to an external device; and
receiving the keyword information corresponding to the at least one piece of character information, and the at least one recommended schedule information from the external device, in response to the at least one piece of character information.

4. The method of claim 3, wherein the at least one piece of recommended schedule information is based on social graph-based information of a user that input the at least one piece of character information.

5. The method of claim 4, wherein the social graph-based information comprises node information detected from information gathered from at least one of a social network service server and a web service server, and information based on a correlation between metadata connected to a social link based on the node information.

6. The method of claim 3, wherein the at least one piece of recommended schedule information comprises social graph node information having a correlation with the keyword information, the keyword information, and another piece of keyword information having a correlation with the social graph node information.

7. The method of claim 3, wherein the external device comprises a server that provides the at least one piece of recommended schedule information.

8. The method of claim 1, wherein displaying the keyword information and the at least one piece of recommended schedule information comprises displaying a recommended schedule information list, wherein a plurality of pieces of completed keyword information are combined.

9. The method of claim 1, wherein displaying the keyword information and the at least one piece of recommended schedule information comprises displaying a recommended information list classified according to domains.

10. The method of claim 1, wherein automatically completing the schedule information comprises touching or clicking the piece of recommended schedule information.

11. The method of claim 1, wherein the plurality of domains are classified according to details of information.

12. The method of claim 1, wherein the at least one piece of character information is input based on a touch provided by the device.

13. An article of manufacture for completing schedule information, comprising a machine readable medium containing one or more programs which when executed implement the steps of:
displaying, on the device, keyword information corresponding to at least one piece of character information, and at least one piece of recommended schedule information selected from a plurality of domains and having a correlation with the keyword information, in response inputting the at least one piece of character information; and
automatically completing schedule information according to at least a selection of a piece of recommended schedule information from the displayed at least one piece of recommended schedule information.

14. A method of completing schedule information, which is performed by a server, the method comprising the steps of:
receiving at least one piece of character information from a device;
obtaining keyword information corresponding to the at least one piece of character information;
obtaining at least one piece of recommended schedule information selected from a plurality of domains, based on the keyword information; and
transmitting the keyword information and the at least one piece of recommended schedule information to the device,
wherein the device automatically completes schedule information by using the keyword information and the at least one piece of recommended schedule information.

15. The method of claim 14, wherein obtaining the keyword information comprises obtaining the keyword information comprising the at least one piece of character information from pre-stored keyword information.

16. The method of claim 14, wherein the at least one piece of recommended schedule information is based on social graph-based information of a user that input the at least one piece of character information.

17. The method of claim 14, wherein the at least one piece of recommended schedule information comprises a recommended schedule information list having a plurality of pieces of completed keyword information combined.

18. The method of claim 14, wherein the at least one piece of recommended schedule information comprises a recommended schedule information list classified according to domains.

19. The method of claim 14, further comprising forming a social graph of a user that input the at least one piece of character information by using the device, based on information gathered from at least one of a social network service server and a web service server, based on a network connection of the user.

20. An article of manufacture for completing schedule information, comprising a machine readable medium containing one or more programs which when executed implement a method comprising the steps of:
receiving at least one piece of character information from a device;
obtaining keyword information corresponding to the at least one piece of character information;
obtaining at least one piece of recommended schedule information selected from a plurality of domains, based on the completed keyword information; and
transmitting the keyword information and the at least one piece of recommended schedule information to the device,
wherein the device automatically completes schedule information by using the keyword information and the at least one piece of recommended schedule information.

21. A device comprising:
a storage unit for storing at least one program;
a user interface unit for interacting with a user; and
at least one processor for executing the at least one program, wherein the at least one program comprises:
a command to display keyword information corresponding to at least one piece of character information, and at least one piece of recommended schedule information selected from a plurality of domains, on the user interface unit, in response to inputting the at least one piece of character information through the user interface unit; and
a command to automatically complete schedule information according to at least a selection of a piece of recommended schedule information from the displayed at least one piece of recommended schedule information, by using the user interface unit.

22. The device of claim 21, wherein the at least one program further comprises:
a command to transmit the at least one piece of character information to an external device; and
a command to receive the keyword information corresponding to the at least one piece of character information, and the at least one piece of recommended schedule information, from the external device, in response to the at least one piece of character information.

23. The device of claim 21, wherein the at least one piece of recommended schedule information is based on social graph-based information of a user that input the at least one piece of character information.

24. A server comprising:
a storage unit for storing at least one program;
a communication unit for communicating through a network; and
at least one processor for executing the at least one program,
the at least one program comprising:
a command to receive at least one piece of character information from a device;
a command to obtain keyword information corresponding to the at least one piece of character information;
a command to obtain at least one piece of recommended schedule information selected from a plurality of domains, based on the keyword information; and
a command to transmit the keyword information and the at least one piece of recommended schedule information to the device,
wherein the device automatically completes schedule information by using the keyword information and the at least one piece of recommended schedule information.

25. The server of claim 24, wherein the at least one program further comprises a command to form a social graph of a user that input the at least one piece of character information by using the device, based on information gathered from at least one of a social network service server and a web service server based on a network connection of the user, and
wherein the at least one piece of recommended schedule information is based on information according to the social graph.
